(19) United States
(12) Patent Application Publication
(10) Pub. No.: US 2020/0058271 A1
(43) Pub. Date: Feb. 20, 2020

(54) DISPLAY CONTROL DEVICE, DISPLAY CONTROL METHOD, AND PROGRAM

(71) Applicant: SONY CORPORATION, TOKYO (JP)

(72) Inventors: Yoshiyasu KUBOTA, KANAGAWA (JP); Masakazu YAJIMA, KANAGAWA (JP); Mari SAITO, KANAGAWA (JP); Akihiro MUKAI, CHIBA (JP); Chisako KAJIHARA, TOKYO (JP)

(21) Appl. No.: 16/346,001

(22) PCT Filed: Oct. 5, 2017
(86) PCT No.: PCT/JP2017/036287

§ 371 Date: Apr. 29, 2019

(30) Foreign Application Priority Data
Nov. 29, 2016 (JP) 2016-231233

(51) Int. Cl. G09G 5/36; G06T 3/40

(52) U.S. Cl. CPC G09G 5/36; G09G 2354/00; G06T 3/40

(57) ABSTRACT

[Object] It is desirable to provide a technique capable of providing more useful information to a user in a case in which there is a target object group in a real world. [Solution] Provided is a display control device, including: a display control unit configured to be capable of controlling display of information related to a first target object which is a group management target and information for managing a target object group including the first target object, in which the display control unit controls a display parameter of each of the information related to the first target object and the information for managing the target object group in accordance with a distance between a user and a second target object included in the target object group.

### TECHNICAL FIELD

The present disclosure relates to a display control device, a display control method, and a program.

### BACKGROUND ART

In recent years, a technique for presenting information related to a target object existing in the real world to a user has become known (for example, see Patent Literature 1). According to such a technique, the user can comprehend the information related to the target object by seeing the information related to the target object. Further, according to such a technique, in a case in which a target object group including a plurality of target objects is located in the real world, information of each of the plurality of target objects included in the target object group is presented to the user.

### CITATION LIST

### Patent Literature

Patent Literature 1: JP 2015-228050A

### DISCLOSURE OF INVENTION

### Technical Problem

However, in a case in which there is a target object group in the real world, the information of each of the plurality of target objects included in the target object group may be useful to the user, and information for managing the target object group may be useful. In this regard, it is desirable to provide a technique capable of providing more useful information to the user in a case in which there is a target object group in the real world.

### Solution to Problem

According to the present disclosure, there is provided a display control device, including: a display control unit configured to be capable of controlling display of information related to a first target object which is a group management target and information for managing a target object group including the first target object. The display control unit controls a display parameter of each of the information related to the first target object and the information for managing the target object group in accordance with a distance between a user and a second target object included in the target object group.

According to the present disclosure, there is provided a display control method, including: controlling display of information related to a first target object which is a group management target and information for managing a target object group including the first target object; and controlling, by a processor, a display parameter of each of the information related to the first target object and the information for managing the target object group in accordance with a distance between a user and a second target object included in the target object group.

According to the present disclosure, there is provided a program causing a computer to function as a display control device including: a display control unit configured to be capable of controlling display of information related to a first target object which is a group management target and information for managing a target object group including the first target object. The display control unit controls a display parameter of each of the information related to the first target object and the information for managing the target object group in accordance with a distance between a user and a second target object included in the target object group.

### Advantageous Effects of Invention

As described above, according to the present disclosure, a technique capable of providing more useful information to a user in a case in which there is a target object group in the real world is provided. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram illustrating a configuration example of a display control system according to an embodiment of the present disclosure.

FIG. 2 is a block diagram illustrating a functional configuration example of a display control device according to the embodiment.

FIG. 3 is a block diagram illustrating a functional configuration example of a server according to the embodiment.

FIG. 4 is a diagram illustrating a state before a worker decides a cow that is a work target.

FIG. 5 is a diagram illustrating an example of a field of view seen by a worker.

FIG. 6 is a diagram illustrating an example of a global view.

FIG. 7 is a diagram illustrating a state after a worker decides a cow that is a work target.

FIG. 8 is a diagram illustrating an example of a field of view seen by a worker.

FIG. 9 is a diagram illustrating an example of a local view.

FIG. 10 is a diagram illustrating a modified example of a local view.

FIG. 11 is a diagram for describing an example of selecting a cow of interest.

FIG. 12 is a diagram illustrating a display example of a list.

FIG. 13 is a diagram illustrating an example of a field of view seen by a worker who performs a predetermined action.

FIG. 14 is a diagram illustrating a state after a worker finishes work on a cow.

FIG. 15 is a diagram illustrating an example of a field of view seen by a worker.

FIG. 16 is a state transition diagram illustrating a first example of an operation of a display control system according to an embodiment of the present disclosure.

FIG. 17 is a state transition diagram illustrating a second example of the operation of the display control system according to the embodiment.

FIG. 18 is a block diagram illustrating a hardware configuration example of a display control device.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that, in the present specification and the drawings, structural elements that have substantially the same or similar function and structure are sometimes distinguished from each other using different numbers after the same reference sign. However, when there is no need in particular to distinguish structural elements that have substantially the same or similar function and structure, the same reference sign alone is attached. Further, there are cases in which similar structural elements of different embodiments are distinguished by adding the same reference numeral followed by different letters. However, in a case where it is not necessary to particularly distinguish each of similar structural element, only the same reference signs are attached.

Further, the description will proceed in the following order.

### 0. Overview

1. Embodiment of the present disclosure
1.1. System configuration example
1.2. Functional configuration example of display control device
1.3. Functional configuration example of server
1.4. Details of functions of display control system
1.4.1. Before cow that is work target is decided
1.4.2. Before work on cow that is work target
1.4.3. After work on cow that is work target
1.4.4. Operation examples
1.5. Hardware configuration example

### 2. Conclusion

### 0. Overview

In recent years, a technique for presenting information related to a target object existing in the real world to a user has become known (for example, see JP 2015-228050A). According to such a technique, the user can comprehend the information related to the target object by seeing the information related to the target object. Further, according to such a technique, in a case in which a target object group including a plurality of target objects is located in the real world, information of each of the plurality of target objects included in the target object group is presented to the user.

However, in a case in which there is a target object group in the real world, information related to each of a plurality of target objects included in the target object group may be useful to the user, and information for managing the target object group may be useful. In other words, whether or not the information of each of a plurality of target objects included in the target object group or the information for managing the target object group is useful to the user may change depending on a situation. A specific example will be described below.

Further, in this specification, a case in which a target object group is a group of farm animals including a plurality of farm animals (particularly, the target object group is a group of cows including a plurality of cows) is mainly assumed. However, the target object group need not be necessarily a group of farm animals. For example, each of a plurality of target objects included in the target object group may be a living object other than a farm animal or may be a non-living object (for example, a mobile object such as a vehicle). Further, in this specification, a case in which there is a group of cows in an outdoor farm is mainly assumed, but the group of cows may be in an indoor farm. Further, in this specification, a case in which the user is a worker who works on a cow is mainly assumed, but the user is not limited to the worker.

As an example, a case in which a worker decides a cow that is a work target from a group of cows and works on that cow is assumed. In this case, the worker refers to information for managing the group of cows before approaching the group of cows, and determines the cow that is the work target on the basis of the information for managing the group of cows. Information related to the group of cows displayed at this time is not detailed information of each of the plurality of cows included in the group of cows but is preferably information necessary for easily determining the cow that is the work target from the group of cows.

On the other hand, in a case in which the worker approaches the group of cows and then performs work on the cow that is the work target, the worker refers to the information related to the cow that is the work target, and performs work on the cow that is the work target (after leading the cow that is the work target to a work place if necessary) on the basis of the information related to the cow that is the work target. Information related to the cow displayed at this time is preferably detailed information related to the cow that is the work target.

As understood also from this example, information useful to the user out of the information of each of the plurality of cows included in the group of cows and the information related to the group of cows can change depending on a situation. In this regard, in this specification, a technique capable of providing more useful information to the worker in a case in which there is a group of cows in the real world will be mainly described.

The overview of the embodiment of the present disclosure has been described above.

### 1. Embodiment of the Present Disclosure

### [1.1. System Configuration Example]

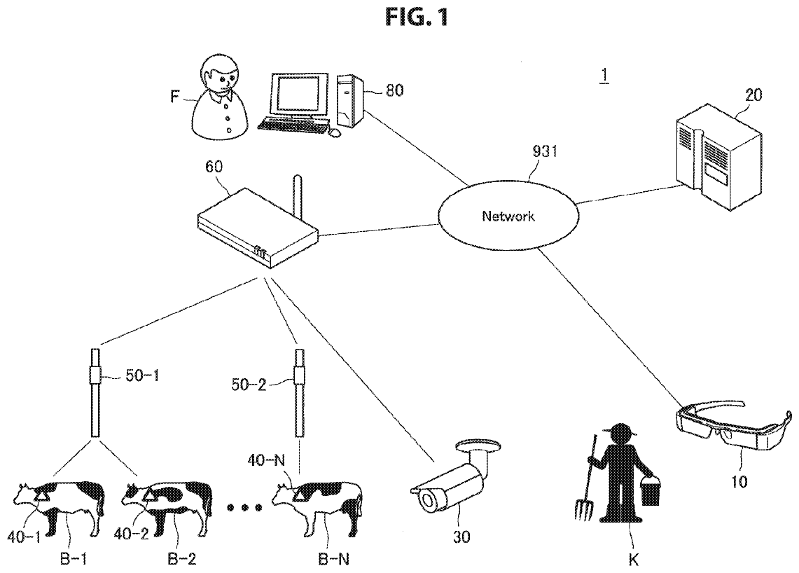

Next, a configuration example of a display control system according to an embodiment of the present disclosure will be described with reference to the appended drawings. FIG. 1 is a diagram illustrating a configuration example of a display control system according to an embodiment of the present disclosure. As illustrated in FIG. 1, a display control system 1 includes a display control device 10, a server 20, an external sensor 30, wearable devices 40-1 to 40-N, repeaters 50-1 and 50-2, a gateway device 60, a terminal 80, and a network 931.

In this specification, a case in which the network 931 is a wireless local area network (LAN) is mainly assumed, but as will be described later, a type of network 931 is not limited. Further, the repeater 50 (the repeaters 50-1 and 50-2) relays communication between the wearable device 40 (the wearable devices 40-1 to 40-N) and the server 20. In the example illustrated in FIG. 1, the number of repeaters 50 is two, but the number of repeaters 50 is not limited to two and is preferably two or more. The gateway device 60 connects the network 931 with the repeater 50 (the repeaters 50-1 and 50-2) and the external sensor 30.

The display control device 10 is a device used by a worker K. In this specification, a case in which the worker K is a breeder breeding cows B-1 to B-N(N is an integer of 2 or more) is mainly assumed. However, the worker K is not limited to the breeder breeding the cows B-1 to B-N. For example, the worker K may be a veterinarian who treats an injury or illness of the cows B-1 to B-N. On the other hand, the terminal 80 is a device used by a clerk F in an office. The display control device 10 and the terminal 80 are connected to the network 931.

Further, in this specification, in consideration of allowing the worker K to efficiently perform manual labor, a case in which the display control device 10 is a type of device that is worn by the worker K (for example, a glasses type, head-mounted display) is assumed. However, the display control device 10 may be a type of device which is not worn by the worker K (for example, a smartphone, a panel display mounted on a wall, or the like). Further, in this specification, a case in which the display control device 10 is a see-through type device is assumed. However, the display control device 10 may be a non-see-through type device.

The external sensor 30 is a sensor not directly attached to the body of a cow B (cows B-1 to B-N). In this specification, a case in which the external sensor 30 is a surveillance camera is mainly assumed, but the external sensor 30 is not limited to the surveillance camera. For example, the external sensor 30 may be a drone equipped with a camera. Further, in this specification, a case in which an image (hereinafter also referred to as an “overhead image”) is obtained by capturing an overhead image of part or all of the cows B (the cows B-1 to B-N) by the external sensor 30 is mainly assumed. However, the direction of the external sensor 30 is not limited.

Further, in this specification, a case in which the external sensor 30 is a visible light camera is mainly assumed. However, a type of external sensor 30 is not limited. For example, the external sensor 30 may be an infrared camera or may be any other type of camera such as a depth sensor capable of acquiring three-dimensional data of a space. The image obtained by the external sensor 30 is transmitted from the external sensor 30 to the server 20 via the gateway device 60 and the network 931.

The server 20 is a device that performs various types of information processing for managing the cow B (the cows B-1 to B-N). Specifically, the server 20 stores information (hereinafter also referred to as “cow information”) in which individual information (including identification information) and position information of the cow B (the cows B-1 to B-N) are associated with each other. The identification information may include individual identification information assigned from a country, an identification number of an Internet of Things (TOT) device, an ID assigned by the worker K, or the like. Then, the server 20 updates the cow information and reads the cow information if necessary.

The individual information includes basic information (a date of birth, a sex, or the like), health information (a body length, a weight, a medical history, a treatment history, a pregnancy history, a health level, or the like), activity information (an exercise history or the like), harvest information (a yield history, milk components, or the like), real-time information (a current situation, information related to work required by a cow, or the like), and a schedule (a treatment schedule, a birthing schedule, or the like). Examples of the information related to the work required by the cow (hereinafter also referred to as “work content”) include injury confirmation, pregnancy confirmation, physical condition confirmation, and the like. Further, examples of the current situation include a current place or state (grazing, a cowshed, milking, or waiting for milking).

The individual information can be input and updated manually or automatically by the worker K. For example, a breeder who is an example of the worker K can determine whether a physical condition of the cow is good or bad by visually observing the state of the cow and input information indicating whether the determined physical condition of the cow is good or bad. A health state on the server 20 is updated depending on whether the physical condition of the cow input by the breeder is good or bad. On the other hand, a veterinarian who is an example of the worker K can diagnose the cow and input a diagnosis result. The health state on the server 20 is updated in accordance with the diagnosis result input by the veterinarian.

Further, in this specification, a case in which the cow information is stored in the server 20 is mainly assumed. However, a location in which the cow information is stored is not limited. For example, the cow information may be stored in a server different from the server 20.

The wearable device 40 (40-1 to 40-N) includes a communication circuit, a sensor, a memory, or the like, and is attached to the body of the cow B (the cows B-1 to B-N). Further, the wearable device 40 transmits the identification number of the IOT device of the corresponding cow B and information specifying the position information to the server 20 via the repeater 50-1, the repeater 50-2, the gateway device 60, and the network 931. Here, various types of information are assumed as information specifying the position information of the cow B.

In the specification, the information specifying the position information of the cow B includes a reception strength of a wireless signal transmitted from each of the repeater 50-1 and the repeater 50-2 at predetermined time intervals in the wearable device 40. Then, the server 20 specifies the position information of the wearable device 40 (the cow B) on the basis of the reception strengths and the position information of each of the repeaters 50-1 and 50-2. Accordingly, in the server 20, it is possible to manage the position information of the cow B in real time.

Further, the information specifying the position information of the cow B is not limited to this example. For example, the information specifying the position information of the cow B may include identification information of a relay station which is a transmission source of a wireless signal received by the wearable device 40 among wireless signals transmitted from the repeaters 50-1 and 50-2 at predetermined time intervals. In this case, the server 20 may specify a position of the relay station identified by the identification information of the relay station of the transmission source as the position information of the wearable device 40 (the cow B).

For example, the information specifying the position information of the cow B may include an arrival period of time (a difference between a transmission time and a reception time) of a signal received from each Global Positioning System (GPS) satellite by the wearable device 40. Further, in this specification, a case in which the position information of the cow B is specified in the server 20 is mainly assumed, but the position information of the cow B may be specified in the wearable device 40. In this case, the position information of the cow B may be transmitted to the server 20 instead of the information specifying the position information of the cow B.

Alternatively, the information specifying the position information of the cow B may be an overhead image obtained by the external sensor 30. For example, if the server 20 manages a pattern of the cow B in advance for each individual, it is possible for the server 20 to specify a position of the pattern of the cow B recognized from the overhead image obtained by the external sensor 30 as the position information of the cow B.

Further, identification information (for example, an identification number of the TOT device) is written in the wearable device 40, and the worker K can comprehend the identification information of the wearable device 40 by looking at the wearable device 40. The wearable device 40 also includes a proximity sensor, and in a case in which the wearable device 40 approaches a specific facility, the proximity sensor can detect the specific facility. With the record of the position information of the wearable device 40 and the information related to the facility which the wearable device 40 approaches, a behavior of the cow can be automatically recorded.

For example, the proximity sensor may be installed at a place where milking is performed as an example of a specific facility, and if the wearable device 40 including a proximity sensor communicating with the proximity sensor is associated with a milking record by an automatic milking machine, a cow producing milk and a produced milk amount can be recorded.

The configuration example of the display control system 1 according to an embodiment of the present disclosure has been described above.

### [1.2. Functional Configuration Example of Display Control Device]

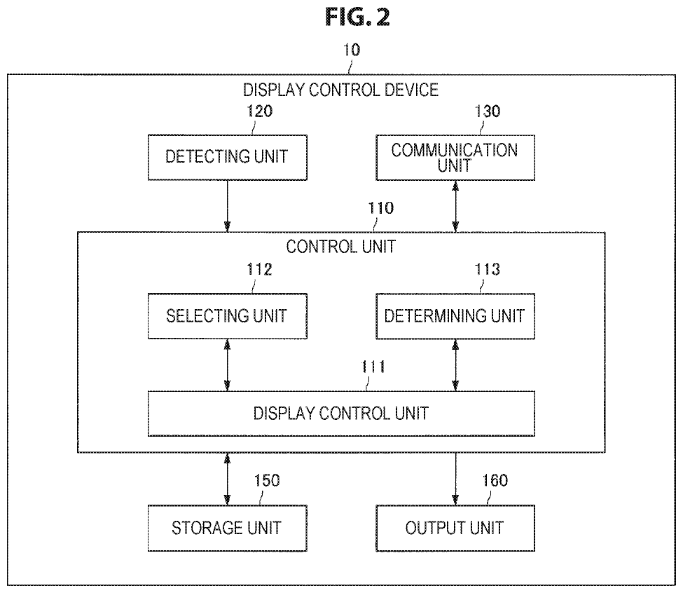

Next, a functional configuration example of the display control device 10 according to an embodiment of the present disclosure will be described. FIG. 2 is a block diagram illustrating a functional configuration example of the display control device 10 according to an embodiment of the present disclosure. As illustrated in FIG. 2, the display control device 10 includes a control unit 110, a detecting unit 120, a communication unit 130, a storage unit 150, and an output unit 160. The functional blocks of the display control device 10 will be described below.

The control unit 110 controls each unit of the display control device 10. Further, the control unit 110 may be constituted by a processing device such as one or more central processing units (CPUs). In a case in which the control unit 110 is constituted by a processing device such as a CPU, the processing device may be constituted by an electronic circuit. As illustrated in FIG. 2, the control unit 110 includes a display control unit 111, a selecting unit 112, and a determining unit 113. The blocks of the control unit 110 will be described later in detail.

The detecting unit 120 includes a sensor, and can detect a direction in which the worker K in a three-dimensional space is paying attention (hereinafter also referred to simply as a “direction of interest”). In this specification, a case in which a direction of the face of the worker K (the position of the field of view of the worker K) is used as the direction of interest will be mainly described. Here, the direction of the face of the worker K may be detected using any method. As an example, the direction of the face of the worker K may be a direction of the display control device 10. The direction of the display control device 10 may be detected by an axis-of-earth sensor or may be detected by a motion sensor.

The detecting unit 120 can detect the direction indicated by the worker K in a three-dimensional space (hereinafter also referred to simply as an “indication direction”). In this specification, a case in which the line of sight of the worker K is used as the indication direction will be mainly described. Here, the line of sight of the worker K can be detected using any method. As an example, in a case in which the detecting unit 120 includes an imaging device, the line of sight of the worker K may be detected on the basis of an eye region shown in an image obtained by the imaging device.

The direction of interest or the indication direction may be detected on the basis of a detection result by a motion sensor detecting a motion of the worker K (an indication direction in which a position in a three-dimensional space detected by a motion sensor is a front may be detected). The motion sensor may detect an acceleration with the acceleration sensor or may detect an angular velocity with a gyro sensor (for example, a ring type gyroscope or the like). Alternatively, the indication direction may be detected on the basis of a detection result by a tactile device. An example of the tactile device is a pen type tactile device.

Alternatively, the direction of interest or the indication direction may be a direction indicated by a predetermined object (for example, a direction in which a leading end of a stick points) or may be a direction indicated by a finger of the worker K. In a case in which the detecting unit 120 includes an imaging device, the direction in which the predetermined object points and the direction indicated by the finger of the worker K may be detected on the basis of an object and a finger shown in an image obtained by the imaging device.

Alternatively, the indication direction may be detected on the basis of a face recognition result of the worker K. For example, in a case in which the detecting unit 120 has an imaging device, a center position between the eyes may be recognized on the basis of an image obtained by the imaging device, and a straight line extending from the center position between the eyes may be detected as the indication direction.

Alternatively, the direction of interest or the indication direction may be a direction corresponding to speech content of the worker K. In a case in which the detecting unit 120 includes a microphone, the direction corresponding to the speech content of the worker K may be detected on the basis of a voice recognition result for sound information obtained by a microphone. For example, in a case in which the worker K desires to designate an inner side of the field of view as the front in the indication direction, it is sufficient to produce speech indicating the inner side of the field of view (for example, “speech” such as “the cow on the inner side”). Accordingly, text data “the cow on the inner side” is obtained as the voice recognition result for such speech, and the indication direction in which the inner side of the field of view is the front can be detected on the basis of the text data “the cow on the inner side.” Further, the speech content may be “show an overhead image,” “show it from above,” “show the cow on the inner side,” or the like.

Further, the detecting unit 120 can detect various types of manipulations by the worker K. Further, in this specification, a selection manipulation and a switching manipulation are mainly described as examples of various types of manipulations by the worker K. Here, various types of manipulations by the worker K may be detected using any method. As an example, various types of manipulations by the worker K may be detected on the basis of a motion of the worker K.

The detection of the motion of the worker K may be performed using any method. For example, in a case in which the detecting unit 120 includes an imaging device, the motion of the user worker K may be detected from an image obtained by the imaging device. The motion of the worker K may be a wink or the like. Alternatively, the detecting unit 120 may detect the motion of the worker K with a motion sensor. For the motion sensor, an acceleration may be detected by an acceleration sensor, or an angular velocity may be detected by a gyro sensor. Alternatively, the motion of the worker K may be detected on the basis of a voice recognition result.

Alternatively, various types of manipulations by the worker K may be detected on the basis of a position of the body of the worker K (for example, the position of the head) or may be detected on the basis of a posture of the worker K (for example, a posture of the whole body or the like). Alternatively, various types of manipulations by the worker K may be detected on the basis of myoelectricity (for example, myoelectricity of a jaw, myoelectricity of an arm, or the like) or may be detected on the basis of an electroencephalogram. Alternatively, various types of manipulations by the worker K may be manipulations on a switch, a lever, a button, and the like or touch manipulations on the display control device 10.

Further, the detecting unit 120 can detect the position information of the display control device 10 in addition to the direction of the display control device 10. Here, the position information of the display control device 10 may be detected using any method. For example, the position information of the display control device 10 may be detected on the basis of an arrival period of time (a difference between a transmission time and a reception time) of a signal received from each GPS satellite by the display control device 10. Alternatively, in a case in which the display control device 10 can receive wireless signals transmitted from the repeaters 50-1 and 50-2 similarly to the wearable devices 40-1 to 40-N, the position information of the display control device 10 can be detected similarly to the position information of the wearable devices 40-1 to 40-N.

The communication unit 130 includes a communication circuit and has a function of communicating with other devices via the network 931 (FIG. 1). For example, the communication unit 130 is constituted by a communication interface. For example, the communication unit 130 can communicate with the server 20 via the network 931 (FIG. 1).

The storage unit 150 includes a memory and is a recording device that stores a program to be executed by the control unit 110 and data necessary for executing the program. Further, the storage unit 150 temporarily stores data for calculation by the control unit 110. Further, the storage unit 150 may be a magnetic storage device, a semiconductor storage device, an optical storage device, or a magneto-optical storage device.

The output unit 160 outputs various types of information. For example, the output unit 160 may include a display capable of performing visible display to the worker K, or the display may be a liquid crystal display or may be an organic electro-luminescence (EL). Further, the output unit 160 may include an audio output device such as a speaker. Alternatively, the output unit 160 may include a tactile sense presenting device that presents a tactile sense to the worker K (the tactile presenting device includes an oscillator that vibrates in accordance with a predetermined voltage). In particular, in work sites for farm animals or the like, a hands-free manipulation is desirable because there are cases in which the hands are unable to be used for work for the farm animals or the like because they are being used for other work. In this regard, the display is desirably a device that can be worn on the head of the worker K (for example, a head mounted display (HMD)). In a case in which the output unit 160 includes a housing which can be worn on the head of the worker K, the housing may include a display that displays information related to the nearest cow to be described later and information for management of a groups of cows. At this time, the display may be a transmissive display or a non-transmissive display. In a case in which the display is a non-transmissive display, an image captured by an imaging device included in a detecting unit 120 is displayed, and thus the worker K can visually recognize a space corresponding to the field of view.

The functional configuration example of the display control device 10 according to an embodiment of the present disclosure has been described above.

### [1.3. Functional Configuration Example of Server]

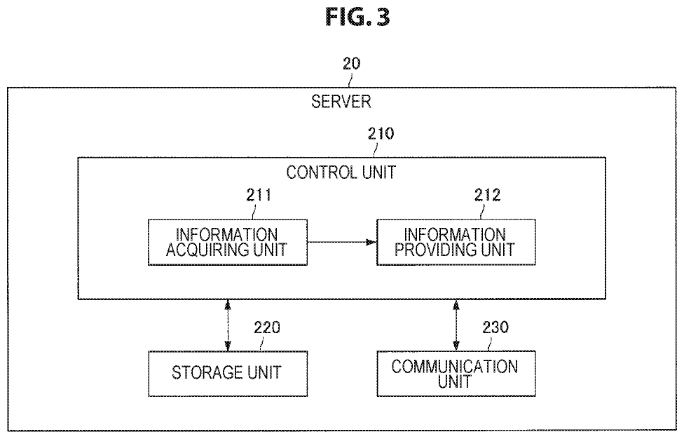

Next, a functional configuration example of the server 20 according to an embodiment of the present disclosure will be described. FIG. 3 is a block diagram illustrating a functional configuration example of the server 20 according to an embodiment of the present disclosure. As illustrated in FIG. 3, the server 20 includes a control unit 210, a storage unit 220, and a communication unit 230. The functional blocks of the server 20 will be described below.

The control unit 210 controls each unit of the server 20. Further, the control unit 210 may be constituted by a processing device such as, for example, one or a plurality of CPUs. In a case in which the control unit 210 is constituted by a processing device such as a CPU, the processing device may be constituted by an electronic circuit. As illustrated in FIG. 3, the control unit 210 includes an information acquiring unit 211 and an information providing unit 212. The blocks of the control unit 210 will be described later in detail.

The storage unit 220 is a recording device that includes a memory, stores a program to be executed by the control unit 210 or stores data (for example, cow information or the like) necessary for executing a program. Further, the storage unit 220 temporarily stores data for calculation by the control unit 210. Further, the storage unit 220 may be a magnetic storage unit device, a semiconductor storage device, an optical storage device, or a magneto-optical storage device.

The communication unit 230 includes a communication circuit and has a function of communicating with other devices via the network 931 (FIG. 1). For example, the communication unit 230 includes a communication interface. For example, the communication unit 230 can communicate with the display control device 10, the external sensor 30 and the wearable device 40 (the wearable devices 40-1 to 40-N) via the network 931 (FIG. 1).

The functional configuration example of the server 20 according to an embodiment of the present disclosure has been described above.

### [1.4. Details of Functions of Display Control System]

Next, the functions of the display control system 1 will be described in detail. In an embodiment of the present disclosure, the display control unit 111 can control display of information related to a first cow which is a management target included in the group of cows and the information for managing the group of cows. Further, the display control unit 111 controls display parameters of each of the information related to the first cow and the information for managing the group of cows in accordance with a distance between the worker K and a second cow included in the group of cows.

According to such a configuration, it is possible to provide more useful information to the worker K in a case in which there is a group of cows in the real world. For example, the display control unit 111 controls display so that the worker K visually recognizes the first cow via a display unit which is an example of the output unit 160. For example, the information related to the first cow includes the individual information of the first cow which is visually recognized by the worker K via the display unit. For example, the information for managing the group of cows may include information of a cow which is not visually recognized by the worker through the display unit in the group of cows and satisfies a predetermined condition. Further, as described above, in work sites for farm animals or the like, a hands-free manipulation is desirable. In this regard, it is desirable for the display control unit 111 to control the display parameters of each of the information related to the first cow and the information for managing the group of cows on the basis of whether or not a condition other than the presence or absence of the touch manipulation and the button manipulation by the worker K is satisfied. Further, although the display parameters are not limited, the display parameters may include a display size of at least a part of the information related to the first cow included in the group of cows and the information for managing the group of cows or may be display/non-display of at least a part. The first cow and the second cow may be identical to or different from each other. Further, the first cow and the second cow will be described later in detail. The information related to the first cow and the information for managing the group of cows will also be described later in detail.

(1.4.1. Before Cow that is Work Target is Decided)

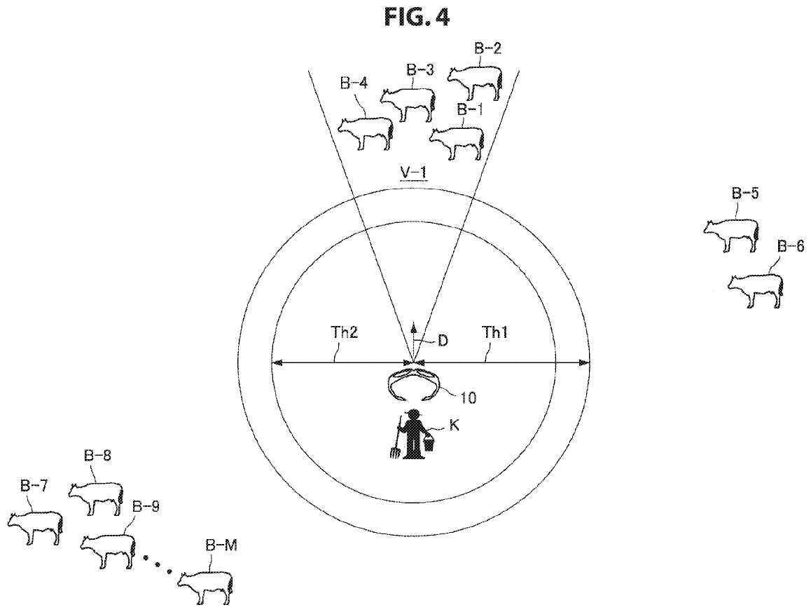

First, a state before the worker K decides the cow that is the work target will be described. FIG. 4 is a diagram illustrating a state before the worker K decides the cow that is the work target. Referring to FIG. 4, the worker K wearing the display control device 10 is located in the real world. Further, a field of view V-1 of the worker K is illustrated. In the display control device 10 worn by the worker K, if the detecting unit 120 detects the position information of the display control device 10, the communication unit 130 transmits the position information of the display control device 10 to the server 20.

In the server 20, if the communication unit 230 receives the position information of the display control device 10, the information acquiring unit 211 decides a group of cows (cows B-1 to B-M) (M is an integer of 2 or more) closely located at a predetermined distance from the position of display control device 10 (the worker K) on the basis of the position information of the display control device 10 and the position information of each of the cows B-1 to B-N. In this specification, a case in which the group of cows (the cows B-1 to B-M) includes some cows included among the cows B-1 to B-N managed by the server 20 is mainly assumed, but the group of cows (the cows B-1 to B-M) may include all of the cows B-1 to B-N (M may be equal to N).

If the individual information and the position information of each cow of the group of cows (the cows B-1 to B-M) are acquired by the information acquiring unit 211, the information providing unit 212 provides the individual information and the position information of each cow of the group of cows (the cows B-1 to B-M) to the display control device 10 via the communication unit 230.

In the display control device 10, the communication unit 130 receives the individual information and the position information of each cow of the group of cows (the cows B-1 to B-M). Further, the determining unit 113 calculates a distance between the worker K and the second cow nearest to the worker K (hereinafter also referred to as a “nearest cow”) on the basis of the position information of each cow of the group of cows (the cows B-1 to B-M) and the position information of the worker K.

Further, the distance between the worker K and the nearest cow may be calculated by any other technique. For example, in the display control device 10, in a case in which it is possible to receive the wireless signal transmitted from the wearable device 40 (the wearable devices 40-1 to 40-M), the determining unit 113 may calculate the distance between the worker K and the nearest cow on the basis of reception strengths of the wireless signals transmitted from the wearable devices 40-1 to 40-M. Further, the position of the worker K used for distance determination may not be an exact position of the worker K. For example, the position of the worker K may be a relative current position of an HMD measured by a positioning sensor such as a simultaneous localization and mapping (SLAM) camera. Further, the position of the worker K may be corrected (offset) on the basis of a mounting position of the HMD. Similarly to the position of the worker K, the position of the nearest cow may not be an exact position of the nearest cow.

Further, in this specification, a case in which the nearest cow is the cow B-1 closest to the worker K among all the cows in the group of cows (the cows B-1 to B-M) will mainly be described. However, as will be described later, the nearest cow may be a cow closest to the worker K among some cows in the group of cows (the cows B-1 to B-M).

Then, the determining unit 113 determines whether or not the distance between the worker K and the nearest cow B-1 exceeds a second threshold value Th2 (FIG. 4). In a case in which it is determined that the distance between the worker K and the nearest cow B-1 exceeds the second threshold value Th2 (FIG. 4), the display control unit 111 starts display of a first view (hereinafter also referred to as a “global view”). In the example illustrated in FIG. 4, the determining unit 113 determines that the distance between the worker K and the nearest cow B-1 exceeds the second threshold value Th2 (FIG. 4). At this time, the display control unit 111 starts the display of the global view.

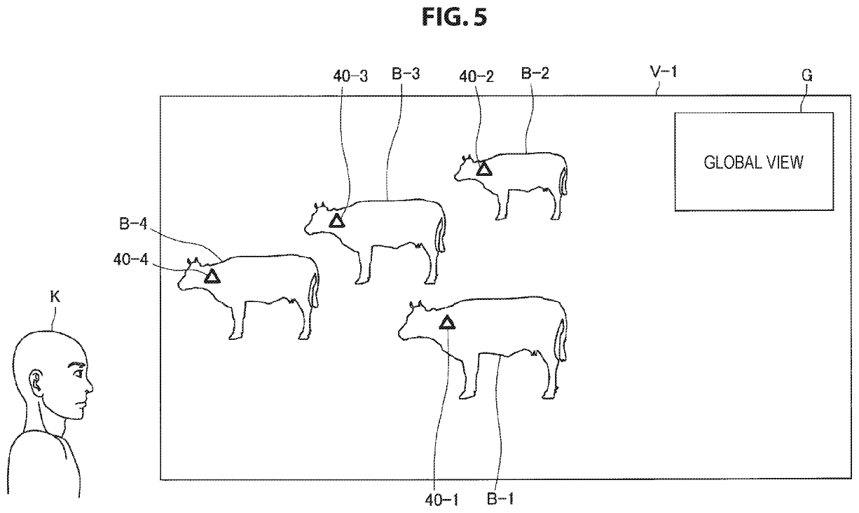

FIG. 5 is a diagram illustrating an example of the field of view V-1 (FIG. 4) seen by the worker K. Here, the field of view V-1 may simply be a field of view of the worker K itself or a range corresponding to a captured image of a sensor (for example, a camera) of the detecting unit 120 or may be a region which can be viewed through a transparent/non-transparent display. Referring to FIG. 5, the cows B-1 to B-4 are located in the field of view V-1. Further, in a case in which it is determined that the distance between the worker K and the nearest cow B-1 exceeds the second threshold value Th2 (FIG. 4), the display control unit 111 controls display of a global view G. Further, in the example illustrated in FIG. 5, the global view G is displayed in an upper right corner of the field of view V-1, but the display position of the global view G is not limited.

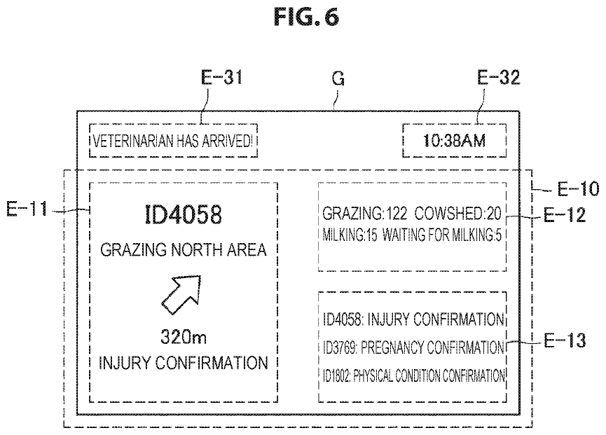

FIG. 6 is a diagram illustrating an example of the global view G. Here, the global view G includes at least a part of the information for managing the group of cows (the cows B-1 to B-M). Referring to FIG. 6, information E-10 for managing the group of cows (the cows B-1 to B-M) includes information E-11 related to a cow which requires work with the highest degree of importance (hereinafter also referred to as a “most important cow”), a headcount E-12 of the group of cows (the cows B-1 to B-M) in each situation, and some work content E-13 required by the group of cows (the cows B-1 to B-M).

The information E-11 related to the most important cow includes an ID of the most important cow, a status of the most important cow, a direction of a position of the most important cow based on the worker K, a distance from the worker K to the most important cow, and information related to work required by the most important cow. Further, the information E-11 related to the most important cow may include history information of the most important cow (various types of histories included in the individual information or the like). Further, some work content E-13 required by the group of cows (the cows B-1 to B-M) include three pieces of content in the descending order of the degree of importance among the work content required by the group of cows (the cows B-1 to B-M). Further, as an example, a case in which “ID4058” is an ID of the cow B-1, “ID3769” is an ID of the cow B-2, and “ID1802” is an ID of the cow B-3 is assumed.

A predetermined mark indicating an end may be attached to work in which a registration action indicating that the work has been completed has been performed among some work content E-13 required by the group of cows (the cows B-1 to B-M). Alternatively, the work in which the registration action indicating that the work has been completed has been performed may be deleted from some work content E-13 required by the group of cows (the cows B-1 to B-M), and work which is not completed by the worker K is listed up and displayed. The registration action indicating that the work has been completed can be performed by various types of manipulations described above.

Further, here, the example in which some work content E-13 required by the group of cows (the cows B-1 to B-M) is decided on the basis of the degree of importance of the work required by the group of cows (the cows B-1 to B-M) has been described. At this time, a predetermined number of work content may be displayed in the descending order of the degree of importance or may be arranged in the descending order of degree of importance. However, the display control unit 111 may decide some work content E-13 required by the group of cows (the cows B-1 to B-M) on the basis of at least one of a type of worker K, work allocated to the worker K, a degree of importance of a work, or the position of the worker K.

For example, in a case in which the type of the worker K is a “skilled person,” the display control unit 111 may include work content without being limited to some work content E-13 required by the group of cows (the cows B-1 to B-M). On the other hand, in a case in which the type of the worker K is an “unexperienced person,” the display control unit 111 adds only some work content (for example, simple work content) in some work content E-13 required by the group of cows (cow B-1 to B-M). Further, in a case in which the type of the worker K is a “veterinarian,” the display control unit 111 adds predetermined work content (for example, “disease treatment”) to some work content E-13 required by the group of cows (the cows B-1 to B-M)).

Alternatively, the display control unit 111 may include only work content allocated to the worker K in some work content E-13 required by the group of cows (the cows B-1 to B-M). The allocation of the work content may be performed such that work content necessary in a predetermined area (for example, in a ranch) is displayed in the form of a list, and the allocation of the work content does not overlap between a plurality of works on the basis of the work content displayed in the form of a list. The allocation may be performed on the basis of a proficiency level, an area which the worker K is responsible for (for example, a cowshed, a milking area, a grazing area, or the like).

Alternatively, the display control unit 111 may add a predetermined number of work content to some work content E-13 required by the group of cows (the cows B-1 to B-M) in order from the cow at a position close to the position of the worker K. Alternatively, the display control unit 111 may arrange the work content in some work content E-13 required by the group of cows (the cows B-1 to B-M) in order from the cow at a position close to the position of the worker K.

In addition, the global view G includes alert information E-31 and current time E-32. In FIG. 6, as an example of the alert information E-31, a character string “veterinarian has arrived!” is illustrated. However, the alert information E-31 is not limited to this example. For example, the alert information E-31 may be a character string “cow does not return to cowshed!” In other words, the alert information may be displayed in a case in which the headcount of each pre-estimated situation is different from the headcount E-12 of each actual situation of the group of cows (the cows B-1 to B-M).

The selection of the nearest cow has been described above. Here, the work content required by the group of cows (the cows B-1 to B-M) may be considered in the selection of the nearest cow. In other words, the selecting unit 112 may select the nearest cow on the basis of the work content required by the cows B-1 to B-M included in the group of cows.

Specifically, the work content required by the group of cows (the cows B-1 to B-M) may influence the selection of the nearest cow in any method. As an example, the selecting unit 112 may specify cows which require a predetermined work from the cows B-1 to B-M included in the group of cows and select the nearest cow from the cows which require the predetermined work. Here, the predetermined work is not limited. For example, the predetermined work may include at least one of injury confirmation, pregnancy confirmation, or physical condition confirmation.

As another example, the selecting unit 112 may perform weighting on the distance between the worker K and the cows B-1 to B-M on the basis of the work content required by each of the cows B-1 to B-M included in the group of cows and select the nearest cow in accordance with the weighted distance. A correspondence between the work content and the weight is not limited. For example, weighting on the distance between the worker K and the cow that does not require the work may be larger than weighting on the distance between the worker K and the cow requiring the work. Alternatively, smaller weighting may be performed on the distance between the worker K and the cow which requires work with a higher degree of importance.

Alternatively, the position of the field of view of the worker K (the direction of the face of the worker K) may be considered in the selection of the nearest cow. In other words, the selecting unit 112 may select the nearest cow on the basis of a positional relation between the field of view of the worker K and each of the cows B-1 to B-M included in the group of cows. Here, the position of the field of view of the worker K may be detected by detecting unit 120 in any method. As an example, the position of the field of view of the worker K may be a direction D (FIG. 4) of the display control device 10. As described above, the direction D of the display control device 10 may be detected by an axis-of-earth sensor or may be detected by a motion sensor.

Specifically, the position of the field of view in the worker K may influence the selection of the nearest cow in any method. As an example, the selecting unit 112 may specify cows corresponding to the field of view of the worker K from the cows B-1 to B-M included in the group of cows and select the nearest cow from the cows corresponding to the field of view of the worker K. Here, the cows corresponding to the field of view of the worker K is not limited. For example, the cows corresponding to the field of view of the worker K may be cows located in the field of view of the worker K or may be cows located within a predetermined angle range on the basis of the center of field of view of the worker K (the direction D of the display control device 10).

As another example, the selecting unit 112 may performing weighting on the distance between the worker K and the cows B-1 to B-M on the basis of the positional relation between the field of view of the worker K and the cows B-1 to B-M included in the group of cows and select the nearest cow in accordance with the weighted distance. A correspondence between the positional relationship and the weight is not limited.

For example, weighting on the distance between the worker K and the cow that is not located within a predetermined angular range on the basis of the center of the field of view of the worker K (the direction D of the display control device 10) may be larger than weighting on the distance between the worker K and the cow that is located within a predetermined angular range on the basis of the center of the field of view of the worker K (the direction D of the display control device 10). Alternatively, smaller weighting may be performed on a distance between the worker K and the cow which is located at a smaller angle on the basis of the center of the field of view of the worker K (the direction D of the display control device 10).

### (1.4.2. Before Work on Cow of Work Target)

Here, as an example, a case in which the worker K decides the cow B-1 (ID 4058) that requires the work with the highest degree of importance as the cow that is the work target with reference to the global view G is assumed. In this case, it is assumed that the worker K approaches the cow B-1 in order to perform work on the cow B-1. A situation after the worker K decides the cow B-1 as the cow that is the work target will be described below. Further, the worker K may decide a cow (any one of the cows B-2 to B-M) other than the cow B-1 which requires work with the highest degree of importance as the cow that is the work target.

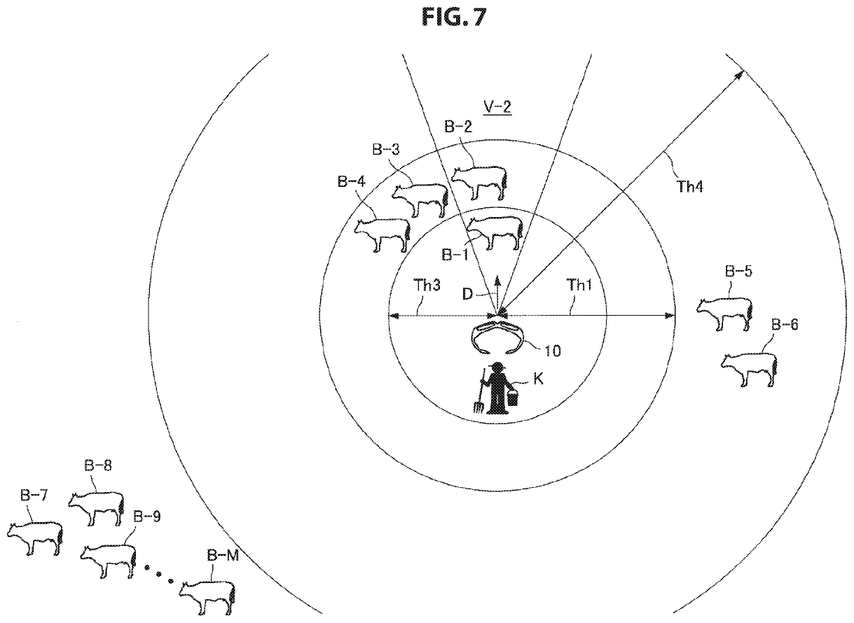

FIG. 7 is a diagram illustrating a state after the worker K decides the cow that is the work target. Referring to FIG. 7, a state in which the worker K approaches the cow B-1 of the work target is illustrated. Further, a field of view V-2 of the worker K is illustrated. In the display control device 10 worn by the worker K, if the detecting unit 120 detects the position information of the display control device 10, the communication unit 130 transmits the position information of the display control device 10 to the server 20.

In the server 20, if the communication unit 230 receives the position information of the display control device 10, the information acquiring unit 211 decides the group of cows (the cows B-1 to B-M) closely located at a predetermined distance from the position of the display control device 10 (the worker K) on the basis of the position information of the display control device 10 and the position information of each of the cows B-1 to B-N. Further, the group of cows (the cows B-1 to B-M) closely located at a predetermined distance from the position of the display control device 10 (the worker K) may change before and after the cow that is the work target is decided by the worker K.

If the individual information and the position information of each cow of the group of cows (the cows B-1 to B-M) are acquired by the information acquiring unit 211, the information providing unit 212 provides the individual information and the position information of each cow of the group of cows (the cows B-1 to B-M) to the display control device 10 via the communication unit 230. In the display control device 10, the communication unit 130 receives the individual information and the position information of each cow of the group of cows (the cows B-1 to B-M). Then, the determining unit 113 calculates the distance between the worker K and the nearest cow on the basis of the position information of each cow of the group of cows (the cows B-1 to B-M) and the position information of the worker K.

Then, the determining unit 113 determines whether or not the distance between the worker K and the nearest cow is less than a first threshold value Th1 (FIG. 7). In a case in which it is determined that the distance between the worker K and the nearest cow B-1 is less than the first threshold value Th1 (FIG. 7), the display control unit 111 stops the display of the global view and starts display of a second view (hereinafter also referred to as a “local view”). In the example illustrated in FIG. 7, the determining unit 113 determines that the distance between the worker K and the nearest cow B-1 is less than the first threshold value Th1 (FIG. 7). At this time, the display control unit 111 stops the display of the global view and starts the display of the local view.

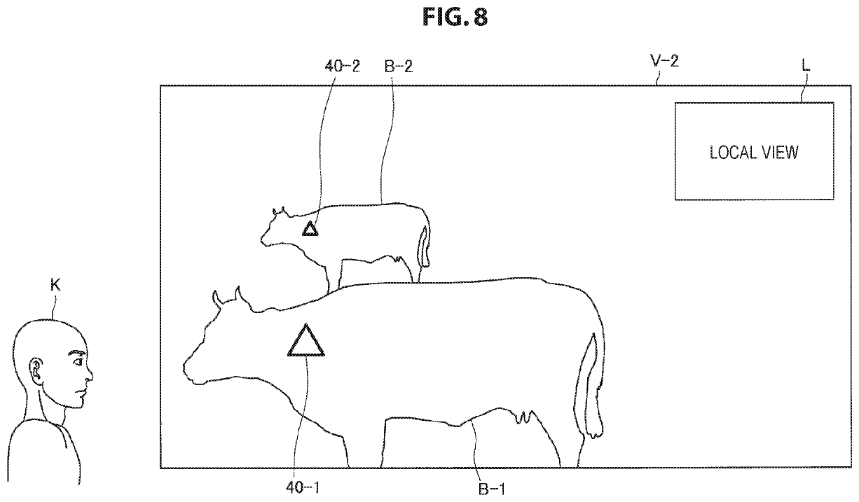

FIG. 8 is a diagram illustrating an example of the field of view V-2 (FIG. 7) seen by the worker K. Referring to FIG. 8, the cow B-1 and B-2 are located in the field of view V-2. Further, in a case in which it is determined that the distance between the worker K and the nearest cow B-1 is less than the first threshold value Th1 (FIG. 7), the display control unit 111 controls display of a local view L. Further, in the example illustrated in FIG. 8, the local view L is displayed in an upper right corner of the field of view V-2, but the display position of the local view L is not limited.

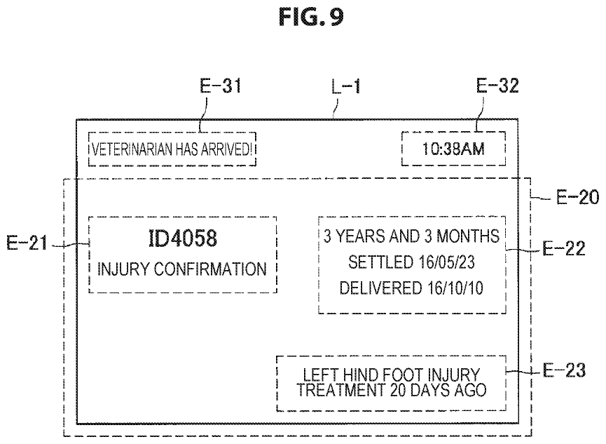

FIG. 9 is a diagram illustrating an example of the local view L. Here, a local view L-1 includes information E-20 related to a first cow not included in the global view G (hereinafter also referred to as a “cow of interest”). Here, a case in which the cow of interest is the cow B-1 closest to the worker K among all the cows in the group of cows (the cows B-1 to B-M) will be mainly described. However, as will be described later, the cow of interest may be the cow nearest to the worker K among some cows in the group of cows (the cows B-1 to B-M).

Alternatively, the cow of interest may be a cow located in an attention direction of the worker K among all the cows in the group of cows (the cows B-1 to B-M) or a cow located in an attention direction of the worker K among some cows in the group of cows (the cows B-1 to B-M). At this time, the cow located in the attention direction of the worker K may be a cow instantaneously located in the attention direction of the worker K or a cow located in the attention direction of the worker K for more than a predetermined period of time. Alternatively, as described later, the cow of interest may be a cow selected on the basis of a selection manipulation by the worker K. Further, the cow of interest may be selected by the selecting unit 112.

Referring to FIG. 9, the information E-20 related to the cow of interest includes an ID of the cow of interest and work content E-21 required by the cow of interest. Further, the information E-20 related to the cow of interest includes an age, a settled date, and a delivery date E-20 of the cow of interest. Further, the information E-20 related to the cow of interest includes a record E-23 of a bad condition of the cow of interest. Further, the information E-20 related to the cow of interest is not limited to this example. For example, the information E-20 related to the cow of interest may include a recent milking amount of the cow of interest.

As in the example illustrated in FIG. 9, the local view L-1 may not include the information E-10 for managing the group of cows (the cows B-1 to B-M) included in global view G. More specifically, the local view L-1 may not include the entire information E-10 for managing the group of cows (the cows B-1 to B-M) which is included in the global view G or may not include part of the information E-10 for managing the group of cows (the cows B-1 to B-M) included in the global view G (for example, the information E-11 related to the most important cow, the headcount E-12 of the group of cows (the cows B-1 to B-M) in each situation, and some work content E-13 required by the group of cows (the cows B-1 to B-M)).

In addition, similarly to the global view G, the local view L-1 includes the alert information E-31 and current time E-32.

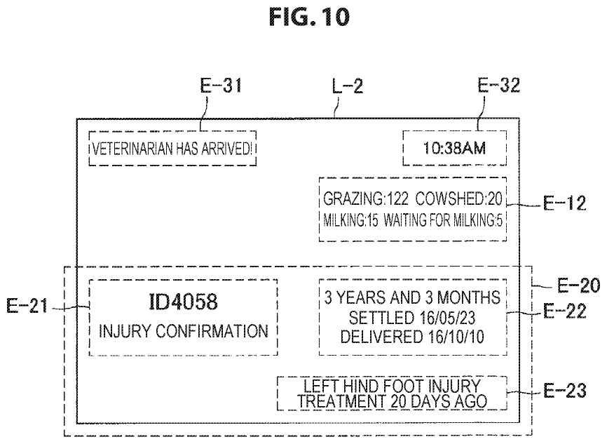

FIG. 10 is a diagram illustrating a modified example of the local view L. Here, a local view L-2 includes information E-20 related to the cow of interest which is not included in the global view G, similarly to the local view L-1 (FIG. 9). Further, the local view L-2 includes at least a part of the information E-10 for managing the group of cows (the cows B-1 to B-M). In the example illustrated in FIG. 10, as an example, the local view L-2 includes a headcount E-12 of the group of cows (the cows B-1 to B-M) in each situation as an example of at least a part of the information E-10 for managing the group of cows (the cows B-1 to B-M).

As in the example illustrated in FIG. 10, the local view L-2 may include at least a part of the information E-10 for managing the group of cows (the cows B-1 to B-M). At this time, a display size of at least a part of the information E-10 for managing the group of cows (the cows B-1 to B-M) included in the local view L-2 (for example, the headcount E-12 of the group of cows (the cows B-1 to B-M) in each situation may be smaller than a display size of at least a part of the information E-10 for managing the group of cows (the cows B-1 to B-M) included in the global view G (for example, the headcount E-12 of the group of cows (the cows B-1 to B-M) in each situation.

In addition, similarly to the global view G, the local view L-2 includes the alert information E-31 and current time E-32.

The selection of the cow of interest has been described above. Here, the work content required by the group of cows (the cows B-1 to B-M) may be considered in the selection of the cow of interest. In other words, the selecting unit 112 may select the cow of interest on the basis of the work content required by the cows B-1 to B-M included in the group of cows.

Specifically, the work content required by the group of cows (the cows B-1 to B-M) may influence the selection of the cow of interest in any method. As an example, the selecting unit 112 may specify cows which require a predetermined work from the cows B-1 to B-M included in the group of cows and select the cow of interest from the cows which require the predetermined work. Here, the predetermined work is not limited. For example, the predetermined work may include at least one of injury confirmation, pregnancy confirmation, or physical condition confirmation.

As another example, the selecting unit 112 may perform weighting on the distance between the worker K and the cows B-1 to B-M on the basis of the work content required by each of the cows B-1 to B-M included in the group of cows and select the cow of interest in accordance with the weighted distance. A correspondence between the work content and the weight is not limited. For example, weighting on the distance between the worker K and the cow that does not require the work may be larger than weighting on the distance between the worker K and the cow requiring the work. Alternatively, smaller weighting may be performed on the distance between the worker K and the cow which requires work with a higher degree of importance.

Alternatively, the position of the field of view of the worker K (the direction of the face of the worker K) may be considered in the selection of the cow of interest. In other words, the selecting unit 112 may select the cow of interest on the basis of a positional relation between the field of view of the worker K and each of the cows B-1 to B-M included in the group of cows. Here, the position of the field of view of the worker K may be detected in any method. As an example, the position of the field of view of the worker K may be a direction D of the display control device 10. The direction D of the display control device 10 may be detected as described above.

Specifically, the position of the field of view in the worker K may influence the selection of the cow of interest in any method. As an example, the selecting unit 112 may specify cows corresponding to the field of view of the worker K from the cows B-1 to B-M included in the group of cows and select the cow of interest from the cows corresponding to the field of view of the worker K. Here, the cows corresponding to the field of view of the worker K is not limited. For example, the cows corresponding to the field of view of the worker K may be cows located in the field of view of the worker K or may be cows located within a predetermined angle range on the basis of the center of field of view of the worker K (the direction D of the display control device 10).

As another example, the selecting unit 112 may performing weighting on the distance between the worker K and the cows B-1 to B-M on the basis of the positional relation between the field of view of the worker K and the cows B-1 to B-M included in the group of cows and select the cow of interest in accordance with the weighted distance. A correspondence between the positional relationship and the weight is not limited.

For example, weighting on the distance between the worker K and the cow that is not located within a predetermined angular range on the basis of the center of the field of view of the worker K (the direction D of the display control device 10) may be larger than weighting on the distance between the worker K and the cow that is located within a predetermined angular range on the basis of the center of the field of view of the worker K (the direction D of the display control device 10). Alternatively, smaller weighting may be performed on a distance between the worker K and the cow which is located at a smaller angle on the basis of the center of the field of view of the worker K (the direction D of the display control device 10).

Further, in a case in which the cow of interest is the cow nearest to the worker K, the cow of interest may be changed each time the cow nearest to the worker K is changed. At this time, the information related to the cow of interest to be displayed may also be changed each time the cow nearest to the worker K is changed. However, for example, in a case in which the worker K desires to continue work on the same cow of interest, the change of the information related to the cow of interest may not be intended by the worker K.

In this regard, as illustrated in FIG. 7, a third threshold value Th3 smaller than the first threshold value Th1 is assumed. Further, in a case in which the distance between the worker K and the cow of interest B-1 is less than the third threshold value Th3, the display control unit 111 may continue the display of the information related to the cow of interest (that is, so that the cow of interest is not changed from the cow B-1 to another target object) even in a case in which the distance between the worker K and another target object (for example, the cow B-2 or the like) is smaller than the distance between the worker K and the cow of interest B-1.

Further, referring to FIG. 4, the second threshold value Th2 is smaller than the first threshold value Th1. As described above, since the first threshold value Th1 is made different from the second threshold value Th2, information in which the behavior of the worker K is taken into consideration is provided to the worker K, and thus information useful to the worker K is expected to be provided to the worker K. However, the first threshold value Th1 and the second threshold value Th2 may be identical to each other.

The case in which the cow of interest is the cow nearest to the worker K among some cows in the group of cows (the cows B-1 to B-M) has been mainly described above. Further, as described above, the cow of interest may be a cow located in the attention direction of the worker K among some cows in the group of cows (the cows B-1 to B-M) or may be a cow selected by the worker K. A case in which the cow of interest is a cow selected on the basis of a selection manipulation by the worker K among some cows in the group of cows (the cows B-1 to B-M) will be described below.

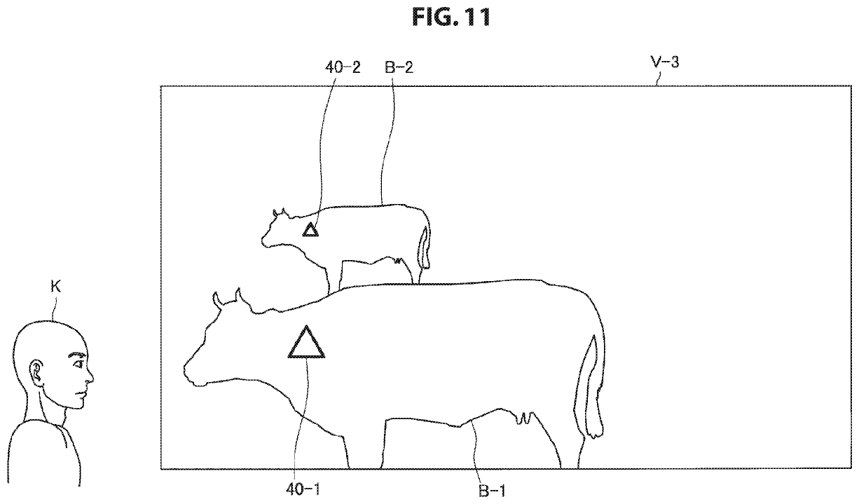

FIG. 11 is a diagram for describing an example of selecting the cow of interest. Referring to FIG. 11, a field of view V-3 seen by the worker K is illustrated. Here, the determining unit 113 decides a cow whose distance to the worker K is less than a fourth threshold value Th4 (FIG. 7) in the group of cows (the cows B-1 to B-M). Here, a case in which the determining unit 113 decides the cows B-1 to B-6 as the cow whose distance to the worker K is less than the fourth threshold value Th4 (FIG. 7). The display control unit 111 controls display of a list of the cows B-1 to B-6 whose distance to the worker K is less than the fourth threshold value Th4 (FIG. 7).

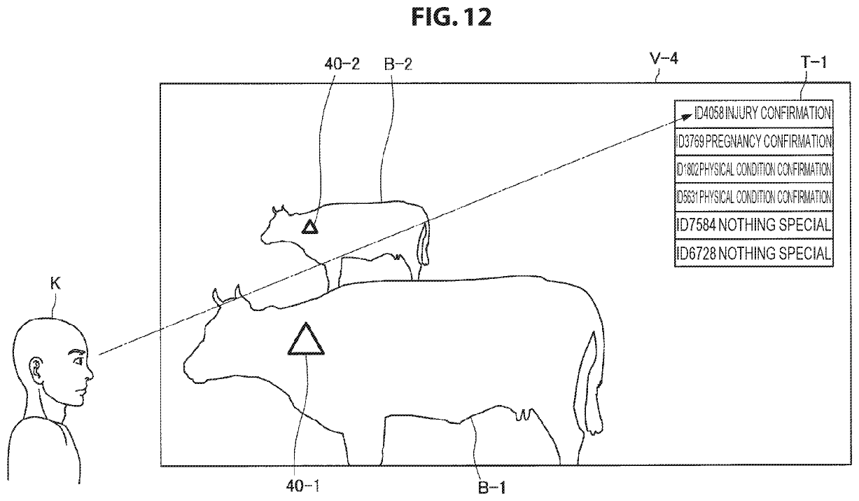

FIG. 12 is a diagram illustrating a display example of the list. Referring to FIG. 12, a field of view V-4 seen by the worker K is illustrated. The display control unit 111 controls display of a list T-1 of the cows B-1 to B-6 whose distance to the worker K is less than the fourth threshold value Th4 (FIG. 7). In the example illustrated in FIG. 12, the list T-1 includes an ID and work content of each of the cows B-1 to B-6, but the information included in the list T-1 is not limited. Further, in the example illustrated in FIG. 12, the list T-1 is displayed in an upper right corner of the field of view V-4, but the display position of the list T-1 is not limited.

Here, as an example, a case in which the worker K decides the cow B-1 (ID4058: injury confirmation) as the cow that is the work target with reference to the list T-1. In this case, the worker K matches the indication direction with the cow B-1 (ID4058: injury confirmation) in the list T-1. FIG. 12 illustrates an example in which the line of sight of the worker K is used as the indication direction. At this time, the display control unit 111 may control display of a pointer to the position of the line of sight. Accordingly, the worker K can easily comprehend the position of the line of sight with the position of the pointer. However, as described above, information other than the line of sight of the worker K may be used as the indication direction. The selecting unit 112 selects the cow B-1 (ID4058: injury confirmation) with which the indication direction matches as the cow of interest.

If the cow of interest is selected, the display control unit 111 may control the display of local view L including the information E-20 related to the cow of interest as described above. Further, it may be possible to cancel the selection of the cow of interest (it may be possible to stop the display of the local view L including the information E-20 related to the cow of interest). For example, if a selection cancellation button is displayed in the field of view V-4, the worker K may cancel the selection of the cow of interest by matching the indication direction with the selection cancellation button.

The example in which the display control unit 111 controls the display parameters of each of the information related to the cow of interest and the information for managing the group of cows in accordance with the distance between the worker K and the nearest cow has been described above. However, the control of the display parameters of each of the information related to the cow of interest and the information for managing the group of cows is not limited to this example. For example, the display control unit 111 may control the display parameters of each of the information related to the cow of interest and the information for managing the group of cows depending on whether or not the worker K performs a predetermined action.

As an example, the worker K may be considered to desire to see the information for managing the group of cows rather than the information related to the cow of interest after the work is finished. In this regard, the predetermined action may be a registration action indicating that the work has been completed. The registration action indicating that the work has been completed can be detected by the detecting unit 120. In other words, the display control unit 111 may cause the display of the local view to be stopped and cause the display of the global view to be started in a case in which the registration action indicating that the work has been completed is detected by the detecting unit 120. The registration action indicating that the work has been completed can be performed by various types of manipulation described above.

Alternatively, the predetermined action may be an explicit switching manipulation by the worker K. In other words, in a case in which the explicit switching manipulation by the worker K is detected by the detecting unit 120, the display control unit 111 may cause the display of the local view to be stopped and cause the display of the global view to be started. The explicit switching manipulation can also be performed by various types of manipulation described above.

Further, for example, a case in which, even in a case in which the worker K is performing the work related to the cow of interest, in a case in which the worker K desires to decide work to be performed next, for example, the worker K is considered to desire to temporarily view the information for managing the group of cows is also considered. In a case in which a predetermined action is performed by the worker K, and a predetermined action is detected by the detecting unit 120, switching from the local view to the global view may be temporarily performed by the display control unit 111.

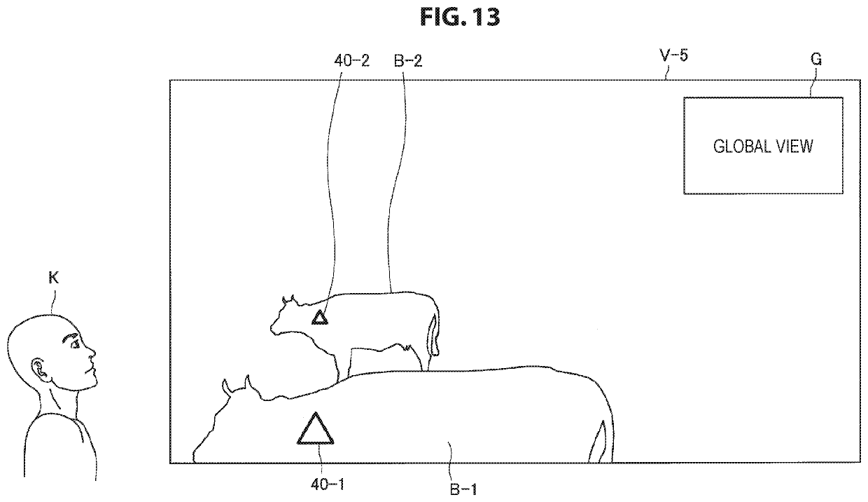

FIG. 13 is a diagram illustrating an example of the field of view seen by the worker K performing a predetermined action. Referring to FIG. 13, a field of view V-5 is illustrated. FIG. 13 illustrates an action of looking up as an example of a predetermined action (that is, an action of tilting the head backward). The inclination of the head can be detected by an acceleration sensor included in the detecting unit 120. The action of tilting the head rearward may be an action of continuing a state in which the head is tilted backward for more than a predetermined angle (for example, 25°) for a predetermined period of time (for example, 1 second). However, the predetermined action is not limited to this example. As illustrated in FIG. 13, the display control unit 111 may stop the display of the local view L and start the display of the global view G in a case in which the predetermined action is performed by the worker K, and the predetermined action is detected by the detecting unit 120. Further, in a case in which a predetermined state of the worker K is detected by the detecting unit 120, the display control unit 111 may perform switching from the local view to the global view. For example, the display control unit 111 may stop the display of the local view L and start the display of the global view G in a case in which the angle of the head of the user (the angle of the display control device 10) exceeds an X° relative to a reference angle (for example, when an angle of a plane parallel to a ground surface is set to 0°).

Further, the action of tilting the head backwards is an action which is not expected to be performed by the worker K during the work, and is similar to a gesture generally performed in a case in which the worker K recalls something. Therefore, the action of tilting the head backward can be recognized as being suitable for the action for switching from the local view L to the global view G.

On the other hand, in a case in which an action of cancelling a predetermined action (that is, an action of cancelling the action of tilting the head backward) is performed by the worker K, and the action of cancelling the predetermined action is detected by the detecting unit 120, the display control unit 111 may stop the display of the global view G and start the display of the local view L. The action of cancelling the action of tilting the head backward may be an action of causing the backward inclination of the head to be less than a predetermined angle (for example, 20°). However, the action of cancelling the predetermined action is not limited to this example. Further, in a case in which a state in which the predetermined state of the worker K is canceled is detected, the switching from the global view to the local view may be performed. For example, in a case in which the angle of the head (the angle of the display control device 10) is less than X° relative to the reference angle (for example, the angle of the plane parallel to the ground is 0°), the display control unit 111 may stop the display of the global view G and start the display of the local view L.

### (1.4.3. After Work on Cow of Work Target)

Next, as an example, a case in which the work on the cow B-1 decided as the cow that is the work target is completed by the worker K is assumed. In this case, it is assumed that the worker K leaves the cow B-1 which is the nearest cow. A case in which the worker K completes the work on the cow B-1 decided as the cow that is the work target will be described below. Further, a case in which the nearest cow is the cow B-1 before and after the work is completed by the worker K is mainly assumed. However, the nearest cows may be different before and after the work is completed by the worker K.

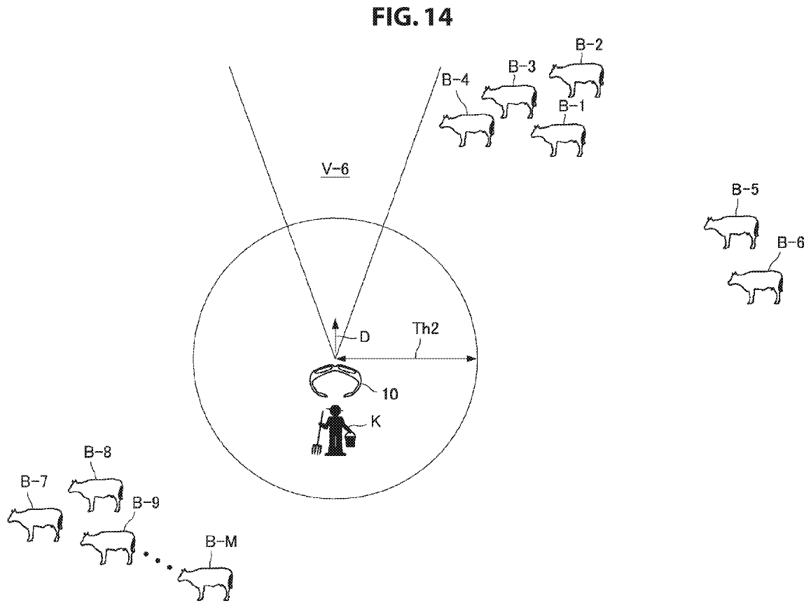

FIG. 14 is a diagram illustrating a state after the worker K completes the work on the cow B-1. Referring to FIG. 14, a state in which the worker K completes the work and leaves the cow B-1 which is the nearest cow is illustrated. Further, a field of view V-6 of the worker K is illustrated. In the display control device 10 worn by the worker K, in a case in which the detecting unit 120 detects the position information of the display control device 10, the communication unit 130 transmits the position information of the display control device 10 to the server 20.

In the server 20, if the communication unit 230 receives the position information of the display control device 10, the information acquiring unit 211 decides the group of cows (the cows B-1 to B-M) closely located at a predetermined distance from the position of the display control device 10 (the worker K) on the basis of the position information of the display control device 10 and the position information of each of the cows B-1 to B-N. Further, the group of cows (the cows B-1 to B-M) closely located at a predetermined distance from the position of the display control device 10 (the worker K) may change before and after the end of the work by the worker K.

If the individual information and the position information of each cow of the group of cows (the cows B-1 to B-M) are acquired by the information acquiring unit 211, the information providing unit 212 provides the individual information and the position information of each cow of the group of cows (the cows B-1 to B-M) to the display control device 10 via the communication unit 230. In the display control device 10, the communication unit 130 receives the individual information and the position information of each cow of the group of cows (the cows B-1 to B-M). Then, the determining unit 113 calculates the distance between the worker K and the nearest cow on the basis of the position information of each cow of the group of cows (the cows B-1 to B-M) and the position information of the worker K.

Then, the determining unit 113 determines whether or not the distance between the worker K and the nearest cow exceeds the second threshold value Th2 (FIG. 14). In a case in which it is determined that the distance between the worker K and the nearest the cow B-1 exceeds the second threshold value Th2 (FIG. 14), the display control unit 111 stops the display of the local view and starts the display of the global view. In the example illustrated in FIG. 14, the determining unit 113 determines that the distance between the worker K and the nearest the cow B-1 exceeds the second threshold value Th2 (FIG. 14). At this time, the display control unit 111 stops the display of the local view and starts the display of the global view.

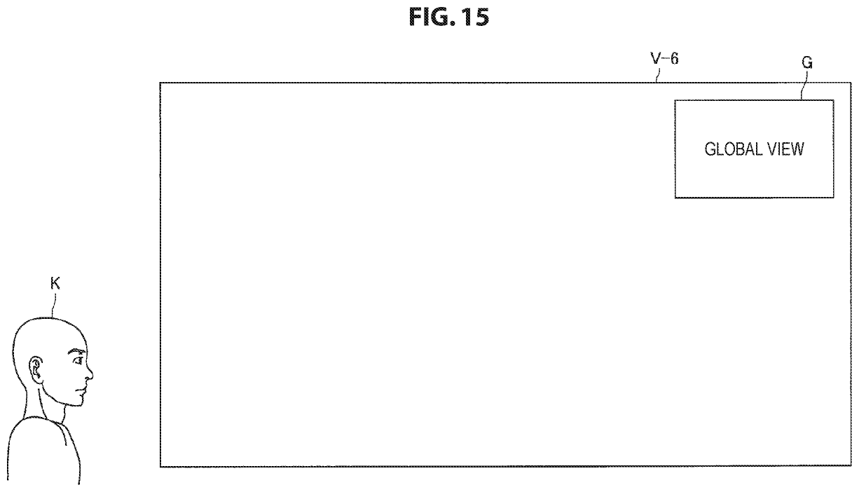

FIG. 15 is a diagram illustrating an example of the field of view V-6 (FIG. 14) seen by the worker K. Referring to FIG. 15, there is no cow located in the field of view V-6. Further, in a case in which it is determined that the distance between the worker K and the nearest the cow B-1 exceeds the second threshold value Th2 (FIG. 14), the display control unit 111 controls the display of the global view G.

The functions of the display control system 1 have been described above in detail.

### (1.4.4. Operation Examples)

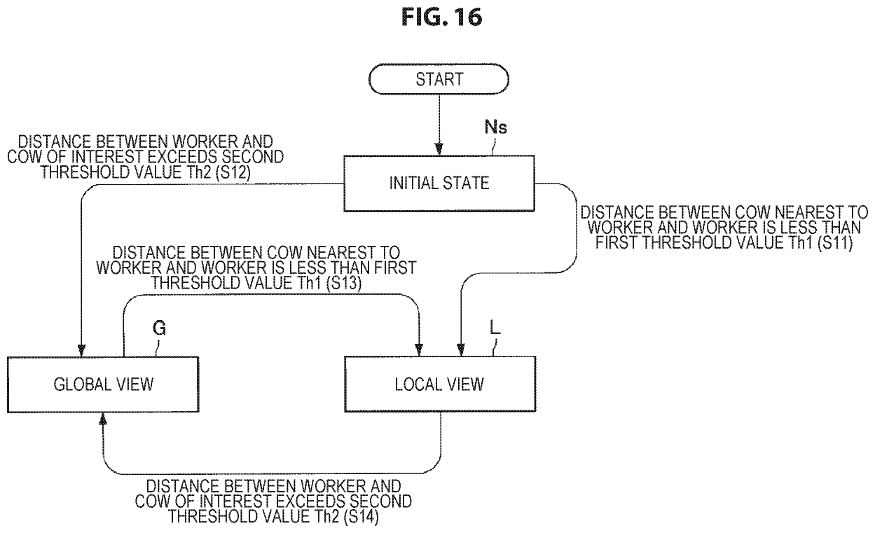

Next, a first example of the operation of the display control system 1 according to an embodiment of the present disclosure will be described. FIG. 16 is a state transition diagram illustrating the first example of the operation of the display control system 1 according to an embodiment of the present disclosure. Further, the state transition diagram illustrated in FIG. 16 merely indicates an example of the operation of the display control system 1. Therefore, the operation of the display control system 1 is not limited to the operation example of the state transition diagram illustrated in FIG. 16.

As illustrated in FIG. 16, if an operation is started, the control unit 110 causes the state to transition to an initial state Ns. In the initial state, in a case in which the determining unit 113 determines that the distance between the cow nearest to the worker K and the worker K is less than the first threshold value Th1 (S11), the display control unit 111 starts the display of the local view L, and the control unit 110 causes the state to transition to the display state of the local view L. On the other hand, in the initial state, in a case in which the determining unit 113 determines that the distance between the worker K and the cow of interest exceeds the second threshold value Th2 (S12), the display control unit 111 starts the display of the global view G, and the control unit 110 causes the state to transition to the display state of the global view G. In the display state of the global view G, in a case in which the determining unit 113 determines that the distance between the cow nearest to the worker K and the worker K is less than the first threshold value Th1 (S13), the display control unit 111 stops the display of the global view G and starts the display of the local view L, and the control unit 110 causes the state to transition to the display state of the local view L. On the other hand, in the display state of the local view L, in a case in which the determining unit 113 determines that the distance between the worker K and the cow of interest exceeds the second threshold value Th2 (S14), the display control unit 111 stops the display of the local view L and starts the display of the global view G, and the control unit 110 causes the state to transition to the display state of the global view G.

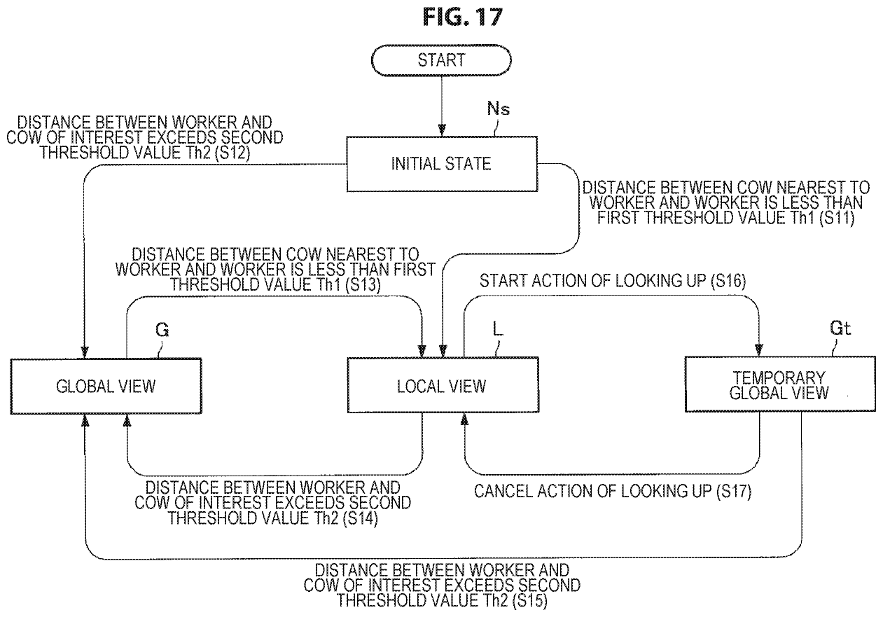

Next, a second example of the operation of the display control system 1 according to an embodiment of the present disclosure will be described. FIG. 17 is a state transition diagram illustrating the second example of the operation of the display control system 1 according to an embodiment of the present disclosure. Further, the state transition diagram illustrated in FIG. 17 merely indicates an example of the operation of the display control system 1. Therefore, the operation of the display control system 1 is not limited to the operation example of the state transition diagram illustrated in FIG. 17.

In the second example illustrated in FIG. 17, similarly to the first example illustrated in FIG. 16, S11 to S14 are executed. As illustrated in FIG. 17, in the display state of the local view L, in a case in which the worker K starts the action of looking up, and the start of the action of looking up is detected by the detecting unit 120 (S16), the display control unit 111 stops the display of the local view L and starts display of a temporary global view Gt, and the control unit 110 causes the state to transition to a display state of the temporary global view Gt. On the other hand, in the display state of the temporary global view Gt, in a case in which the worker K cancels the action of looking up, and the cancellation of the action of looking up is detected by the detecting unit 120 (S17), the display control unit 111 stops the display of a temporary global view Gt and starts the display of the local view L, and the control unit 110 causes the state to transition to the display state of the local view L. In the display state of the temporary global view Gt, in a case in which the determining unit 113 determines that the distance between the worker K and the cow of interest exceeds the second threshold value Th2 (S15), the control unit 110 causes the state to transition to the display state of the global view G.

The example of the operation of the display control system 1 according to an embodiment of the present disclosure has been described above.

### [1.5. Hardware Configuration Example]

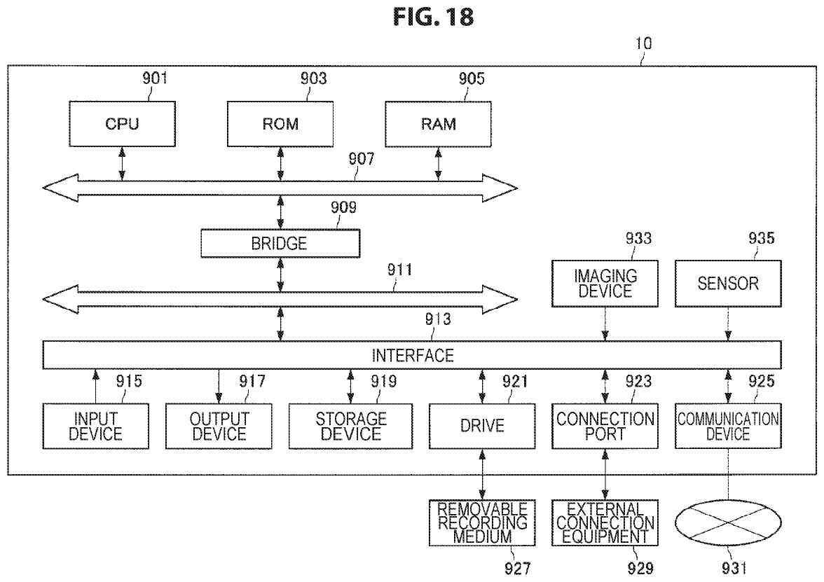

Next, with reference to FIG. 18, a hardware configuration of the display control device 10 according to the embodiment of the present disclosure will be described. FIG. 18 is a block diagram illustrating the hardware configuration example of the display control device 10 according to the embodiment of the present disclosure. Further, the hardware configuration of the server 20 according to an embodiment of the present disclosure can be realized, similarly to the hardware configuration example of the display control device 10 illustrated in FIG. 18.

As illustrated in FIG. 18, the display control device 10 includes a central processing unit (CPU) 901, read only memory (ROM) 903, and random access memory (RAM) 905. The control unit 110 can be realized by the CPU 901, the ROM 903 and the ROM 905. In addition, the display control device 10 may include a host bus 907, a bridge 909, an external bus 911, an interface 913, an input device 915, an output device 917, a storage device 919, a drive 921, a connection port 923, and a communication device 925. Moreover, the display control device 10 may include an imaging device 933 and a sensor 935, as necessary. The display control device 10 may include a processing circuit such as a digital signal processor (DSP) or an application specific integrated circuit (ASIC), alternatively or in addition to the CPU 901.

The CPU 901 serves as an arithmetic processing device and a control device, and controls the overall operation or a part of the operation of the display control device 10 according to various programs recorded in the ROM 903, the RAM 905, the storage device 919, or a removable recording medium 927. The ROM 903 stores programs, operation parameters, and the like used by the CPU 901. The RAM 905 temporarily stores programs used when the CPU 901 is executed, and parameters that change as appropriate when executing such programs. The CPU 901, the ROM 903, and the RAM 905 are connected with each other via the host bus 907 configured from an internal bus such as a CPU bus. In addition, the host bus 907 is connected to the external bus 911 such as a Peripheral Component Interconnect/Interface (PCI) bus via the bridge 909.

The input device 915 is a device operated by a user such as a button. The input device 915 may include a mouse, a keyboard, a touchscreen, a button, a switch, a lever and the like. The input device 915 may include a microphone configured to detect voice of users. The input device 915 may be a remote control device that uses, for example, infrared radiation and another type of radio waves. Alternatively, the input device 915 may be external connection equipment 929 such as a mobile phone that corresponds to an operation of the display control device 10. The input device 915 includes an input control circuit that generates input signals on the basis of information which is input by a user to output the generated input signals to the CPU 901. A user inputs various types of data and indicates a processing operation to the display control device 10 by operating the input device 915. In addition, the imaging device 933 (to be described later) may function as the input device by capturing an image of movement of hands of a user or capturing a finger of a user. In this case, a pointing position may be decided in accordance with the movement of the hands or a direction of the finger. Further, the detecting unit 120 can be realized by the input device 915.

The output device 917 includes a device that can visually or audibly report acquired information to a user. The output device 917 may be, for example, a display device such as a liquid crystal display (LCD), an organic electro-luminescence (EL), a sound output device such as a speaker or a headphone, or the like. Further, the output device 917 may include a plasma display panel (PDP), a projector, a hologram, a printer, or the like. The output device 917 outputs a result obtained through a process performed by the display control device 10, in the form of text or video such as an image, or sounds such as voice and audio sounds. In addition, the output device 917 may include a light or the like to light the surroundings. Further, the output unit 160 can be realized by the output device 917.

The storage device 919 is a device for data storage that is an example of the storage unit of the display control device 10. The storage device 919 includes, for example, a magnetic storage device such as a hard disk drive (HDD), a semiconductor storage device, an optical storage device, or a magneto-optical storage device. The storage device 919 stores therein various data and programs executed by the CPU 901, and various data acquired from an outside.

The drive 921 is a reader/writer for the removable recording medium 927 such as a magnetic disk, an optical disc, a magneto-optical disk, and a semiconductor memory, and built in or externally attached to the display control device 10. The drive 921 reads out information recorded on the mounted removable recording medium 927, and outputs the information to the RAM 905. The drive 921 writes the record into the mounted removable recording medium 927.

The connection port 923 is a port used to directly connect equipment to the display control device 10. The connection port 923 may be a USB (Universal Serial Bus) port, an IEEE1394 port, and a Small Computer System Interface (SCSI) port, or the like. In addition, the connection port 923 may be an RS-232C port, an optical audio terminal, an HDMI (registered trademark) (High-Definition Multimedia Interface) port, and so on. The connection of the external connection equipment 929 to the connection port 923 makes it possible to exchange various kinds of data between the display control device 10 and the external connection equipment 929.

The communication device 925 is a communication interface including, for example, a communication device for connection to the network 931. The communication device 925 may be, for example, a wired or wireless local area network (LAN), Bluetooth (registered trademark), or a communication card for a wireless USB (WUSB). The communication device 925 may also be, for example, a router for optical communication, a router for asymmetric digital subscriber line (ADSL), or a modem for various types of communication. For example, the communication device 925 transmits and receives signals in the Internet or transmits signals to and receives signals from another communication device by using a predetermined protocol such as TCP/IP. The network 931 to which the communication device 925 connects is a network established through wired or wireless connection. The network 931 is, for example, the Internet, a home LAN, infrared communication, radio communication, or satellite communication. Further, the communication unit 130 can be realized by the communication device 925.

The imaging device 933 is a device that captures images of a real space by using an image sensor such as a charge coupled device (CCD) or a complementary metal oxide semiconductor (CMOS), and various members such as a lens for controlling image formation of a subject image onto the image sensor, and generates the captured images. The imaging device 933 may capture a still image or a moving image. Further, the detecting unit 120 can be realized by the imaging device 933.

The sensor 935 is various sensors such as a ranging sensor, an acceleration sensor, a gyro sensor, a geomagnetic sensor, a vibration sensor, an optical sensor, and a sound sensor. The sensor 935 acquires information regarding a state of the display control device 10 such as a posture of a housing of the display control device 10, and information regarding an environment surrounding the display control device 10 such as luminous intensity and noise around the display control device 10. The sensor 935 may include a global positioning system (GPS) sensor that receives GPS signals to measure latitude, longitude, and altitude of the device. Further, the detecting unit 120 can be realized by the sensor 935.

### 2. Conclusion

As described above, according to an embodiment of the present disclosure, a display control device including a display control unit configured to be capable of controlling display of information related to a first target object and information related to a target object group including the first target object, in which the display control unit controls display parameters of the information related to the first target object and the information related to the target object group in accordance with a distance between a user and a second target object included in the target object group. Accordingly, in a case in which there is a target object group in the real world, it is possible to provide more useful information to the user.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, the position of each component is not particularly limited as long as the operations of the display control device 10 and the server 20 are realized. Some of the processes of the respective units in the display control device 10 may be performed by the server 20. As a specific example, some or all of the blocks (the display control unit 111, the selecting unit 112, and the determining unit 113) included in the control unit 110 in the display control device 10 may be installed in the server 20 or the like. Further, some of the processes of the respective units in the server 20 may be performed by the display control device 10. Further, in addition to the display control device 10 and the server 20, for example, one or more relay devices (not illustrated) that perform the processes of some of the respective units may be installed in the display control system 1. In this case, the relay device may be, for example, a smartphone carried by the user. For example, the relay device includes a communication circuit for communicating with the display control device 10 and the server 20 and a processing circuit for performing some of the processes performed by the respective blocks in the embodiment in the housing of the relay device. Further, when the relay device receives predetermined data from, for example, the communication unit 230 of the server 20, performs the processes of some of the respective units, and transmits data to the communication unit 130 of the display control device 10 on the basis of a processing result or performs communication and processes in an opposite direction, effects similar to those of the embodiment of the operations of the display control device 10 and the server 20 are obtained.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

A display control device, including:

a display control unit configured to be capable of controlling display of information related to a first target object which is a group management target and information for managing a target object group including the first target object,

in which the display control unit controls a display parameter of each of the information related to the first target object and the information for managing the target object group in accordance with a distance between a user and a second target object included in the target object group.

(2)

The display control device according to (1), in which

the display control unit controls display such that the user visually recognizes the first target object via a display unit, and

the information related to the first target object includes individual information of the first target object which is visually recognized by the user via the display unit, and the information for managing the target object group includes information of a target object which is not visually recognized by the user via the display unit in the target object group and satisfies a predetermined condition.

(3)

The display control device according to (2), further including:

a housing configured to be worn on a head of the user; and

a display installed in the housing and configured to display the information related to the first target object and the information for managing the target object group including the first target object,

in which the display control unit controls a display parameter of each of the information related to the first target object and the information for managing the target object group on the basis of whether or not a condition other than presence or absence of a touch manipulation and a button manipulation by the user is satisfied.

(4)

The display control device according to (3), in which, in a case in which a predetermined action or predetermined state of the user is detected while the information related to the first target object is being displayed by the display, the display control unit stops the display of the information related to the first target object and starts the display of the information for managing the target object group.

(5)

The display control device according to any one of (1) to (4), in which the display control unit starts the display of the information related to the first target object in a case in which the distance between the user and the second target object is less than a first threshold value, and stops the display of the information related to the first target object in a case in which a distance between the user and the first target object exceeds the second threshold value.

(6)

The display control device according to (5), in which the display control unit starts display of at least a part of the information for managing the target object group in a case in which the distance between the user and the first target object exceeds the second threshold value, and stops display of the at least a part of the information for managing the target object group in a case in which the distance between the user and the second target object is less than the first threshold value.

(7)

The display control device according to (5), in which, in a case in which the distance between the user and the second target object is less than a first threshold value, the display control unit reduces a display size of the at least a part of the information for managing the target object group to be smaller than in a case in which the distance between the user and the first target object exceeds the second threshold value.

(8)

The display control device according to any one of (5) to (7), in which, in a case in which the distance between the user and the first target object is less than a third threshold value smaller than the first threshold value, the display control unit continues the display of the information related to the first target object even in a case in which a distance between the user and another target object is smaller than the distance between the user and the first target object.

(9)

The display control device according to any one of (1) to (8), in which the display control device comprises a selecting unit configured to select at least one of the first target object or the second target object on the basis of information related to work required by each of a plurality of target objects included in the target object group.

(10)

The display control device according to (9), in which the selecting unit specifies target objects requiring predetermined work from the plurality of target objects included in the target object group, and selects at least one of the first target object or the second target object from the target objects requiring the predetermined work.

(11)

The display control device according to (9), in which the selecting unit performs weighting on a distance between the user and the plurality of target objects on the basis of information related to the work required by each of the plurality of target objects included in the target object group, and selects at least one of the first target object or the second target object in accordance with the weighted distance.

(12)

The display control device according to any one of (1) to (8), in which the display control device comprises a selecting unit configured to select at least one of the first target object or the second target object on the basis of a positional relation between a field of view of the user and each of a plurality of target objects included in the target object group.

(13)

The display control device according to (12), in which the selecting unit specifies target objects corresponding to the field of view from the plurality of target objects included in the target object group, and selects at least one of the first target object or the second target object from the target objects corresponding to the field of view.

(14)

The display control device according to (12), in which the selecting unit performs weighting on a distance between the user and the plurality of target objects on the basis of the positional relation between the field of view of the user and each of the plurality of target objects included in the target object group, and selects at least one of the first target object or the second target object in accordance with the weighted distance.

(15)

The display control device according to any one of (1) to (14), in which the first target object is a farm animal,

the information related to the first target object includes information regarding work required by the farm animal which is the first target object or a history of the farm animal, and

the information for managing the target object group includes the number of farm animals in a group in each situation.

(16)

The display control device according to any one of (1) to (14), in which the information for managing the target object group includes information related to work required by at least some target objects in the target object group.

(17)

The display control device according to (16), in which the display control unit decides information related to the work included in the information for managing the target object group on the basis of at least one of a type of the user, work allocated to the user, a degree of importance of the work, or a position of the user.

(18)

The display control device according to any one of (1) to (17), in which the first target object and the second target object are the same target object.

(19)

A display control method, including:

controlling display of information related to a first target object which is a group management target and information for managing a target object group including the first target object; and

controlling, by a processor, a display parameter of each of the information related to the first target object and the information for managing the target object group in accordance with a distance between a user and a second target object included in the target object group.

(20)

A program causing a computer to function as a display control device including:

a display control unit configured to be capable of controlling display of information related to a first target object which is a group management target and information for managing a target object group including the first target object,

in which the display control unit controls a display parameter of each of the information related to the first target object and the information for managing the target object group in accordance with a distance between a user and a second target object included in the target object group.

### REFERENCE SIGNS LIST

1 display control system
10 display control device
110 control unit
111 display control unit
112 selecting unit
113 determining unit
120 detecting unit
130 communication unit
150 storage unit
160 output unit
20 server
210 control unit
211 information acquiring unit
212 information providing unit
220 storage unit
230 communication unit
30 external sensor
40 wearable device
50 repeater
60 gateway device
80 terminal
Th2 second threshold value
Th1 first threshold value
Th3 third threshold value
Th4 fourth threshold value

1. A display control device, comprising:
a display control unit configured to be capable of controlling display of information related to a first target object which is a group management target and information for managing a target object group including the first target object,
wherein the display control unit controls a display parameter of each of the information related to the first target object and the information for managing the target object group in accordance with a distance between a user and a second target object included in the target object group.

2. The display control device according to claim 1, wherein
the display control unit controls display such that the user visually recognizes the first target object via a display unit, and
the information related to the first target object includes individual information of the first target object which is visually recognized by the user via the display unit, and the information for managing the target object group includes information of a target object which is not visually recognized by the user via the display unit in the target object group and satisfies a predetermined condition.

3. The display control device according to claim 2, further comprising:
a housing configured to be worn on a head of the user; and
a display installed in the housing and configured to display the information related to the first target object and the information for managing the target object group including the first target object,
wherein the display control unit controls a display parameter of each of the information related to the first target object and the information for managing the target object group on a basis of whether or not a condition other than presence or absence of a touch manipulation and a button manipulation by the user is satisfied.

4. The display control device according to claim 3, wherein, in a case in which a predetermined action or predetermined state of the user is detected while the information related to the first target object is being displayed by the display, the display control unit stops the display of the information related to the first target object and starts the display of the information for managing the target object group.

5. The display control device according to claim 1, wherein the display control unit starts the display of the information related to the first target object in a case in which the distance between the user and the second target object is less than a first threshold value, and stops the display of the information related to the first target object in a case in which a distance between the user and the first target object exceeds the second threshold value.

6. The display control device according to claim 5, wherein the display control unit starts display of at least a part of the information for managing the target object group in a case in which the distance between the user and the first target object exceeds the second threshold value, and stops display of the at least a part of the information for managing the target object group in a case in which the distance between the user and the second target object is less than the first threshold value.

7. The display control device according to claim 5, wherein, in a case in which the distance between the user and the second target object is less than a first threshold value, the display control unit reduces a display size of the at least a part of the information for managing the target object group to be smaller than in a case in which the distance between the user and the first target object exceeds the second threshold value.

8. The display control device according to claim 5, wherein, in a case in which the distance between the user and the first target object is less than a third threshold value smaller than the first threshold value, the display control unit continues the display of the information related to the first target object even in a case in which a distance between the user and another target object is smaller than the distance between the user and the first target object.

9. The display control device according to claim 1, wherein the display control device comprises a selecting unit configured to select at least one of the first target object or the second target object on a basis of information related to work required by each of a plurality of target objects included in the target object group.

10. The display control device according to claim 9, wherein the selecting unit specifies target objects requiring predetermined work from the plurality of target objects included in the target object group, and selects at least one of the first target object or the second target object from the target objects requiring the predetermined work.

11. The display control device according to claim 9, wherein the selecting unit performs weighting on a distance between the user and the plurality of target objects on a basis of information related to the work required by each of the plurality of target objects included in the target object group, and selects at least one of the first target object or the second target object in accordance with the weighted distance.

12. The display control device according to claim 1, wherein the display control device comprises a selecting unit configured to select at least one of the first target object or the second target object on a basis of a positional relation between a field of view of the user and each of a plurality of target objects included in the target object group.

13. The display control device according to claim 12, wherein the selecting unit specifies target objects corresponding to the field of view from the plurality of target objects included in the target object group, and selects at least one of the first target object or the second target object from the target objects corresponding to the field of view.

14. The display control device according to claim 12, wherein the selecting unit performs weighting on a distance between the user and the plurality of target objects on a basis of the positional relation between the field of view of the user and each of the plurality of target objects included in the target object group, and selects at least one of the first target object or the second target object in accordance with the weighted distance.

15. The display control device according to claim 1, wherein the first target object is a farm animal,
the information related to the first target object includes information regarding work required by the farm animal which is the first target object or a history of the farm animal, and
the information for managing the target object group includes a number of farm animals in a group in each situation.

16. The display control device according to claim 1, wherein the information for managing the target object group includes information related to work required by at least some target objects in the target object group.

17. The display control device according to claim 16, wherein the display control unit decides information related to the work included in the information for managing the target object group on a basis of at least one of a type of the user, work allocated to the user, a degree of importance of the work, or a position of the user.

18. The display control device according to claim 1, wherein the first target object and the second target object are the same target object.

19. A display control method, comprising:
controlling display of information related to a first target object which is a group management target and information for managing a target object group including the first target object; and
controlling, by a processor, a display parameter of each of the information related to the first target object and the information for managing the target object group in accordance with a distance between a user and a second target object included in the target object group.

20. A program causing a computer to function as a display control device comprising:
a display control unit configured to be capable of controlling display of information related to a first target object which is a group management target and information for managing a target object group including the first target object,
wherein the display control unit controls a display parameter of each of the information related to the first target object and the information for managing the target object group in accordance with a distance between a user and a second target object included in the target object group.
